(19) United States
(12) Patent Application Publication
(10) Pub. No.: US 2022/0212378 A1
(43) Pub. Date: Jul. 7, 2022

(54) METHOD FOR THE MANUFACTURE OF A FOAMED EXTRUDATE

(71) Applicant: Promix Solutions AG, Winterthur (CH)

(72) Inventors: Christian Schlummer, Winterthur (CH); Christoph Willa, Winterthur (CH); Rolf Heusser, Winterthur (CH)

(73) Assignee: Promix Solutions AG, Winterthur (CH)

(21) Appl. No.: 17/553,174

(22) Filed: Dec. 16, 2021

(30) Foreign Application Priority Data
Jan. 5, 2021 (EP) 21150349.5

(51) Int. Cl. B29C 44/34; B29B 7/42; B29B 7/88; B29B 7/82; B29B 7/74

(52) U.S. Cl. CPC B29C 44/3442; B29B 7/426; B29B 7/7404; B29B 7/82; B29B 7/88

(57) ABSTRACT

A method for producing a foamed extrudate comprises a device containing a main melting device and an auxiliary melting device. A first melt is generated in the main melting device, a second melt is generated in the auxiliary melting device from a meltable starting material. At least one reactive additive is added to the meltable starting material, wherein the at least one reactive additive being selected from the group consisting of a chemical blowing agent and an active nucleating agent is mixed in the auxiliary melting device with the second melt, so that an additive-containing second melt is obtained in the auxiliary melting device which is added to the first melt.

### CROSS-REFERENCE TO RELATED APPLICATIONS

This application claims the benefit of European patent application no. EP 21150349.5, filed Jan. 5, 2021, the contents of which is incorporated herein by reference in its entirety.

### TECHNICAL FIELD

The present invention relates to a method for producing a fine cell foamed plastic or plastic extrudate or a functionally comparable mass or an extrudate containing biopolymers or natural substances, for example wood, plants, wood components or plant components. For the sake of simplicity, the starting materials for such extrudates are referred to below as meltable starting materials. Foamed plastic extrudates are obtained in accordance with known methods by chemical foaming or physical foaming by way of an extrusion process. The plastic is melted, and a blowing agent is added. With chemical foaming, chemical substances are added which decompose under the influence of heat and release a gas which then leads to a foaming reaction in the plastic melt. In physical foaming, a gas, or a low-boiling liquid such as CO2, nitrogen or butane is added to the plastic melt. In addition, chemical substances, so-called active nucleating agents, are added to create a fine-cell foam structure which, under the influence of heat, release small amounts of gases which, in combination with the physical blowing agent, foam up so that a fine-cell foam structure is obtained. The liquid or gaseous physical blowing agents are added under pressure to the melted plastic by means of a pump or other conveying device. The chemical blowing agents and the active nucleating agents are chemical substances that are present as solids. For example, these chemical substances can contain azodicarbonamides, sodium bicarbonate, citric acid, and citric acid derivatives. The term active substance, when this term relates to substances, for example nucleating agents, is understood to mean a substance which splits off a gas. In particular, the term “active nucleating agent” is used to enable a distinction to be made with respect to passive nucleating agents. Passive nucleating agents consist of a large number of small particles on or by means of which no chemical reaction takes place.

In conventional extrusion systems, these chemical substances are added as a granulate or powder to the plastic granulate, preferably in the feed section of the extruder. Granulates are preferred because they generate less dust and can be metered more easily using gravimetric or volumetric metering devices. Such granulates can comprise a so-called masterbatch. A masterbatch typically contains 30-70% by weight of chemical substances and a carrier material, which can be for example a wax or plastic. A masterbatch is produced in an upstream process, for example a compounding process. The masterbatch is usually added to a plastic in the form of granulate or powder in a concentration of 0.1 to 4 percent by weight. The chemical reaction then takes place in the extruder after the plastic and the masterbatch have melted as soon as the melt temperature in the extruder has reached the reaction temperature required for the chemical reaction.

It has been shown that satisfactory fine-cell foams cannot always be obtained with the previously described chemical and physical foaming processes. Fine-cell foam is understood to be a foam with an average cell size of less than 200 micrometers. In particular, the addition of the chemical substances in the inlet section of the extruder has proven to be disadvantageous in some cases. If an extrusion process includes degassing, at least one of chemical substances or gases released by the reaction of the chemical substances can escape. Degassing is provided if volatile substances or moisture are to be removed from the plastic melt in the extruder. The degassing takes place in part by applying a vacuum. If chemical substances are added to the plastic melt that are required for chemical foaming or active nucleation, these substances or gases released by the reaction of the chemical substances can also escape through a degassing opening provided for degassing purposes.

The addition of chemical substances in the inlet section of the extruder has also proven to be disadvantageous if the desired chemical reaction does not initiate or cannot be completed due to the melt temperatures being too low. This is particularly the case when the reaction temperature is higher than the melt temperature or when the melt temperature is only higher than the reaction temperature for a short period of time. One reason for low melt temperatures can be that the melt decomposes at higher temperatures.

### Description of Related Art

Document DE 3722050 A1 discloses an extrusion method for producing a foamed or foamable plastic melt. In this extrusion method, chemical blowing agents, physical blowing agents and active nucleating agents, which are referred to as pore-forming agents, are optionally used. A pore-forming agent and a chemical blowing agent are not added to a first extruder in the feed area, but rather downstream in an additional feed opening. The addition takes place as granulate or as a powder in a section free from pressure of the first extruder. This method has the major disadvantage that the residence time of the chemical substances in the extruder is shortened because the chemical substances are not added in the inlet section of the extruder, but only shortly before the plastic melt is discharged near the discharge end of the extruder. As a result, the residence time of the chemical substances in the extruder is reduced, with the result that the melt temperature is potentially above the reaction temperature of the chemical substances for a short time, especially since the melt temperature is typically reduced again towards the discharge end of an extruder during foaming.

The previously known method is also unsuitable for foaming temperature-sensitive extrudates in which the melt temperature does not correspond to the reaction temperature of the chemical substances, or only for an insufficient duration. If the melt temperature in the last section of the extruder is kept very high in order to achieve sufficient progress of the chemical reaction despite the short residence time of the chemical substances, there is a risk that the hot plastic melt and the granulate or powder will undergo a chemical reaction immediately upon contact and thus gas produced by the chemical reaction can at least partially escape via the metering point.

In addition, special metering screws are required to add the granulate or powder in this way, which are free from pressure in the section containing the feed opening so that the granulates and powder can be added without the plastic melt being forced out of the feed opening.

For further mixing and cooling of the plastic melt, it is proposed according to DE 3722050 A1 to feed the plastic melt loaded with the pore-forming agent and the chemical blowing agent to a second extruder after the first extruder. Theoretically, optimal conditions for the reaction of the chemical substances in the second extruder could be set. However, upon such a modification, the second extruder could no longer fulfill the function of the cooling extruder, by means of which the temperature of the plastic melt is lowered to an ideal temperature for the foaming process. In i5 addition, the use of two extruders is expensive and complex in terms of process technology if a sufficient reaction of the chemical substances is required.

### SUMMARY OF THE INVENTION

The object of the invention is to provide a method by means of which fine-cell foams can be produced by way of an extrusion method even under unfavorable process conditions.

If the term “for example” is used in the following description, this term relates to exemplary embodiments and/or variants, which is not necessarily to be understood as a more preferred application of the teaching of the invention. The terms “preferably”, “preferred” are to be understood in a similar manner by referring to an example from a set of embodiments and/or variants, which is not necessarily to be understood as a preferred application of the teaching of the invention. Accordingly, the terms “for example”, “preferably” or “preferred” can relate to a plurality of embodiments and/or variants.

The following detailed description contains various embodiments for the method according to the invention. The description of a particular method is to be regarded as exemplary only. In the description and claims, the terms “contain”, “comprise”, “have” are interpreted as “including, but not limited to”.

A method for producing a foamed extrudate contains a main melting device and an auxiliary melting device, a first melt being generated in the main melting device, a second melt being generated from a meltable starting material in the auxiliary melting device, the meltable starting material comprising at least one reactive additive from the group consisting of a chemical blowing agent, a physical blowing agent and an active nucleating agent which is added or the reactive additive is contained in the meltable starting material, the meltable starting material and the reactive additive being melted in the auxiliary melting device to form the second melt, so that an additive-containing second melt containing the reactive additive is obtained in the auxiliary melting device, which is added to the first melt produced in the main melting device. In particular, by means of the concentration of the reactive additive in the second melt, a second melt temperature profile can be set in the second melt in the auxiliary melting device, which can be set independently of a first melt temperature profile of the first melt of the main melting device. In particular, by means of the diameter or the length of the auxiliary melting device, a second residence time of the second melt in the auxiliary melting device can be set, which can be adjusted independently of a first residence time of the first melt in the main melting device.

According to an embodiment, the main melting device is configured as a main extruder. According to an embodiment, the auxiliary melting device is configured as a secondary extruder. According to an embodiment, the auxiliary melting device is configured as a single-screw extruder.

According to an embodiment, the meltable starting material is added to the auxiliary melting device via a feed device as powder or as a granulate. According to an embodiment, at least one of the reactive additives is added to the auxiliary melting device as a powder or as granulate. According to an embodiment, the granulates which contain the reactive additive are configured as a masterbatch. According to an embodiment, no additional meltable starting material is added to the masterbatch. The masterbatch can in particular contain the reactive additive. The masterbatch can contain a plastic. The masterbatch can be added to the second melt located in the auxiliary melting device in undiluted form or additionally with further plastic granulate or plastic powder.

According to an embodiment, the metering ratio of the second melt to the first melt is less than 1 to 10. According to an embodiment, the metering ratio is less than 1:20. According to an embodiment, the metering ratio is less than 1:50. It is thus possible by means of the method according to the invention to provide the processing of reactive additives for different volumetric flows of melts. The incorporation of reactive additives thus becomes scalable through the use of the method according to the invention.

According to an embodiment, the total amount of reactive additives of the second melt in relation to the entire plastic amount of the second melt amounts to 10% to 80% by weight.

According to an embodiment, the metered quantity of the reactive additive can be controlled by the angular velocity of the auxiliary melting device. In particular, the angular velocity of a rotatable conveying device arranged in the auxiliary melting device is regulated by a throughput-dependent manipulated variable of the main melting device. The throughput-dependent manipulated variable can include the angular velocity of a rotatable main conveyor device arranged in the main melting device or an angular velocity of a melt pump can be regulated which is arranged in the first melt emerging from the main melting device.

According to an embodiment, additive-containing second melt is added to the first melt in the main melting device or downstream of the main melting device.

According to an embodiment, the main melting device contains a degassing opening, the additive-containing second melt being added downstream of the degassing opening.

According to an embodiment, a chemical reaction of the reactive additive takes place partially before it is added to the first melt.

According to an embodiment, the temperature of the second melt or the additive-containing second melt in the auxiliary melting device reaches a value of more than 160 degrees Celsius at least in a section of the auxiliary melting device. According to an embodiment, the temperature of the second melt or the additive-containing second melt in the auxiliary melting device reaches more than 180 degrees Celsius at least in a section of the auxiliary melting device. According to an embodiment, the temperature of the second melt or the additive-containing second melt in the auxiliary melting device reaches more than 200 degrees Celsius at least in a section of the auxiliary melting device.

According to an embodiment, the temperature of the second melt or the additive-containing second melt is higher than the temperature of the first melt before the first melt and the additive-containing second melt are mixed.

According to an embodiment, at least an element of a group consisting of a first mixing device and a first cooling device is arranged downstream of the main melting device.

According to an embodiment, at least one element from a group consisting of a second mixing device and a second cooling device is arranged between the auxiliary melting device and the addition to the first melt, so that the additive-containing second melt can be mixed or cooled before it comes into contact with the first melt.

In order to obtain an optimal effect of the reactive additive, it must have reacted as completely as possible and the split off gas and decomposition products have to be distributed as evenly as possible in the additive-containing second melt.

In particular, in order to achieve an optimal effect of the chemical blowing agents and active nucleating agents, they must have reacted as completely as possible, and the split-off gas and the decomposition products have to be distributed as evenly as possible in the additive-containing second melt. This is achieved by exposing the reactive additive as long as possible to temperatures above the reaction temperature of the reactive additive.

Therefore, according to an embodiment, the reactive additive is added to the meltable starting material in a feed device of the auxiliary melting device, for example as granulate, as a masterbatch or as a powder. The reactive additive is optimally premixed with the meltable starting material and has a maximum residence time in the auxiliary melting device. In addition, the addition of the reactive additive in a feed device is remarkably simple. The reactive additive can be added together with the meltable starting material via a metering device suitable for the solids. The second melt is configured as a foamable or foamed second melt by way of the reactive additive.

According to an embodiment, the method for producing a foamed extrudate also includes physical foaming. At least one physical blowing agent is added to the extrudate to carry out the physical foaming according to this embodiment, wherein the physical blowing agent can be added to the additive-containing second melt in the auxiliary melting device, in the main melting device or downstream of the main melting device.

Chemical blowing agents or active nucleating agents can release gases via endothermic or exothermic reactions. Chemical blowing agents and active nucleating agents with an endothermic reaction process can contain, for example, sodium bicarbonate, citric acid, and citric acid derivatives. Chemical blowing agents and active nucleating agents with an exothermic reaction process can contain azodicarbonamides, for example.

The meltable starting materials can contain an element of the group consisting of plastics and natural substances.

The method can be used in particular for a plastic, for example for at least one plastic from the group consisting of PET, PP, PE, PS, PC, PA, TPE, TPU, ABS, PVC.

The method can be used in particular for natural substances, for example for at least one natural substance from the group consisting of a biopolymer, wood, a plant, a wood component, or a plant component.

The method can also be used for mixtures of plastics and natural materials.

According to the invention, a reactive additive from the group consisting of a chemical blowing agent and an active nucleating agent in concentrated form is melted in a melting device serving as an auxiliary melting device and metered into a main melting device as a blowing agent-containing melt in a first melt, also referred to as the main stream. The main stream is a melt obtained in a main melting device. In this way, reactive additive can be metered in after any degassing of the first melt. Process conditions such as temperature and residence time can be set in the auxiliary melting device independently of the main melting device. The residence time and potential reaction time of the reactive additive can therefore also be adjusted via the size of the auxiliary melting device and/or the concentration of the chemical substances in relation to the second melt. The temperature control in the auxiliary melting device can take place independently of the temperature control in the main melting device. Therefore, ideal conditions for the complete reaction of the chemical blowing agents and/or the active nucleating agents can be maintained at any point in time, and the escape of any propellant gases that may arise can be prevented.

### BRIEF DESCRIPTION OF THE DRAWINGS

The method according to the invention is illustrated below with the aid of a few exemplary embodiments. It is shown in

FIG. 1 a diagram of a method according to a first embodiment,

FIG. 2 a diagram of a method according to a second embodiment,

FIG. 3 a diagram of a method according to a third embodiment.

### DETAILED DESCRIPTION

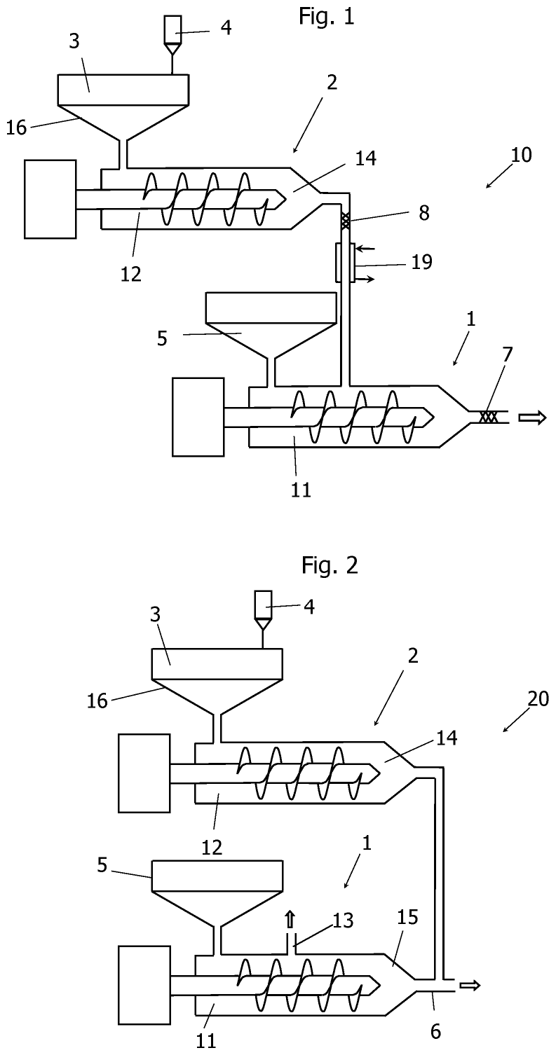

FIG. 1 shows a device 10 for carrying out a method for producing a foamed extrudate according to a first embodiment. The device 10 contains a main melting device 1 and an auxiliary melting device 2, a first melt 11 being generated in the main melting device 1. In the auxiliary melting device 2, a second melt 12 is produced from a meltable starting material 3. The meltable starting material 3 can be in the form of a powder or a granulate. A reactive additive 4 is added to the meltable starting material 3. The reactive additive 4 can, for example, be in the form of a powder, a granulate or a masterbatch. A masterbatch can also be used without any further meltable starting material 3. The meltable starting material 3 is melted together with the reactive additive 4 in the secondary melting device 2 to form the second melt 12, so that an additive-containing second melt 14 containing the reactive additive 4 is obtained in the auxiliary melting device 2, which is mixed with the first melt 11 generated in the main melting device 1. The main melting device 1 can also be charged with a meltable starting material 5 which is present as a solid, for example as a powder or granulate. According to an embodiment not shown, the main melting device 1 is supplied with a melt instead of a solid.

For example, the main melting device 1 is configured as a main extruder. For example, the auxiliary melting device 2 is configured as a secondary extruder, in particular as a single-screw extruder. Due to the simple construction, the auxiliary melting device 2 can be obtained inexpensively in the configuration as a single-screw extruder; in addition, an auxiliary melting device 2 can simply be connected to a main melting device 1 or retrofitted.

According to an embodiment, at least one of the reactive additives 4 is added to the auxiliary melting device 2 as a powder or as a granulate. The reactive additive 4 can already be added to the meltable starting material 3 in the feed device 16. If a masterbatch is processed by means of the auxiliary melting device 2, the reactive additive 4 can be contained in the masterbatch.

According to an embodiment, the metering ratio of the second melt 12 with respect to the first melt 11 is less than 1 to 10. According to an embodiment, the metering ratio is less than 1:20. According to an embodiment, the metering ratio is less than 1:50.

According to the embodiment shown in FIG. 1, the additive-containing second melt 14 is added to the first melt 11 in the main melting device 1. In particular, a chemical reaction of the reactive additive 4 can partially take place in the auxiliary melting device 2. In particular, the additive-containing second melt 14 can reach a temperature higher than 160 degrees Celsius at least in a section of the auxiliary melting device 2. According to an embodiment, the additive-containing second melt 14 can reach a temperature higher than 180 degrees Celsius at least in a section of the auxiliary melting device 2. According to an embodiment, the additive-containing second melt 14 can reach a temperature higher than 200 degrees Celsius at least in a section of the auxiliary melting device 2. The temperature of the additive-containing second melt 14 can be higher than the temperature of the first melt 11 before the first melt 11 and the second melt 12 or the additive-containing second melt 14 are mixed.

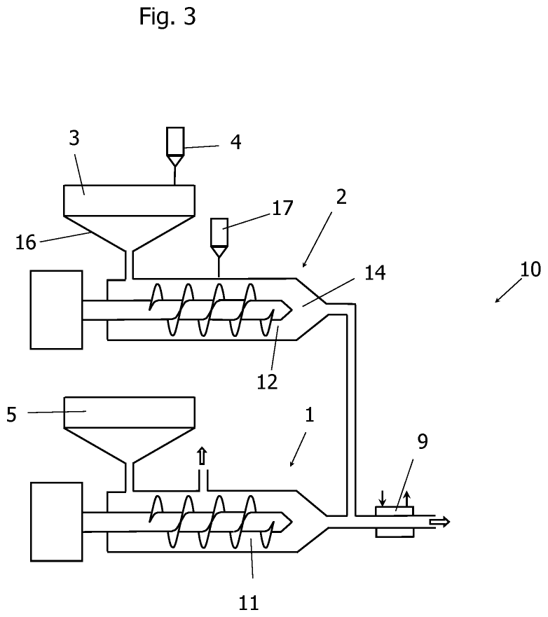

According to the present embodiment, an optional first mixing device 7 is arranged downstream of the main melting device 1. Optionally, a first cooling device 9 is additionally arranged downstream of the main melting device 1. The first cooling device 9 is shown by way of example in FIG. 3.

According to the embodiment shown in FIG. 1, an optional second mixing device 8 and an optional second cooling device 19 are arranged downstream of the auxiliary melting device 2 so that the additive-containing second melt can be mixed or cooled before it is brought into contact with the first melt 11.

FIG. 2 shows a device 20 for carrying out a method for producing a foamed extrudate according to a second embodiment. The same reference numerals as in FIG. 1 are used for elements that are the same or have the same effect.

The device 20 contains a main melting device 1 and an auxiliary melting device 2, a first melt 11 being generated in the main melting device 1. In the auxiliary melting device 2, a second melt 12 is produced from a meltable starting material 3, which is present, for example, as a powder or as a granulate. A reactive additive 4 is added to the meltable starting material 3 or the reactive additive 4 is already contained in the meltable starting material 3. The meltable starting material 3 is melted together with the additive 4 in the auxiliary melting device 2 to form the second melt 12, so that in the auxiliary melting device 2 an additive-containing second melt 14 containing the reactive additive 4 is obtained, which is mixed with the first melt 11 generated in the main melting device 1. The main melting device 1 can also be charged with a meltable starting material 5 which is present as a solid, in particular as a powder or granulate. According to an embodiment not shown, the main melting device 1 can be supplied with a melt instead of a solid.

According to an embodiment, the auxiliary melting device 2 is configured as a secondary extruder, in particular as a single-screw extruder. Due to the simple construction, the auxiliary melting device 2 can be obtained inexpensively in the configuration as a single-screw extruder; in addition, this auxiliary melting device 2 can simply be connected to an existing main melting device 1 or retrofitted.

According to an embodiment, at least the reactive additive 4 is added to the auxiliary melting device 2 as a powder, as a granulate or as a masterbatch. The reactive additive 4 can already be added to the meltable starting material 3 in the feed device 16. If a masterbatch is processed by means of the auxiliary melting device 2, the reactive additive 4 can be contained in the masterbatch.

According to an embodiment, the metering ratio of the second melt 12 with respect to the first melt 11 is less than 1 to 10. According to an embodiment, the metering ratio is less than 1:20. According to an embodiment, the metering ratio is less than 1:50.

In particular, a chemical reaction of the reactive additive 4 can partially take place in the auxiliary melting device 2. In particular, the additive-containing second melt 14 can reach a temperature higher than 160 degrees Celsius at least in a section of the auxiliary melting device 2. According to an embodiment, the additive-containing second melt 14 can reach a temperature higher than 180 degrees Celsius at least in a section of the auxiliary melting device 2. According to an embodiment, the additive-containing second melt 14 can reach a temperature higher than 200 degrees Celsius at least in a section of the auxiliary melting device 2. The temperature of the additive-containing second melt 14 can be higher than the temperature of the first melt 11 before the first melt 11 and the second melt 12 or the additive-containing second melt 14 are mixed.

According to the embodiment shown in FIG. 2, the additive-containing second melt 14 is added to the first melt 11 downstream of the main melting device 1.

According to this embodiment, the main melting device 1 contains a degassing opening 13, the additive-containing second melt 14 containing the reactive additive 4 being added downstream of the degassing opening 13. According to this embodiment, the additive-containing second melt 14 is added downstream of the outlet end 15 of the main melting device 1, for example in a conduit 6.

According to an embodiment (not shown), the additive-containing second melt 14 can also be added to a section of the main melting device 1 which is located between the degassing opening and the outlet end 15. Mixing devices 7, 8 or a cooling device 9 can be provided as in the first embodiment. A mixing device and/or a cooling device can follow after the main melting device.

FIG. 3 shows a device 10 for carrying out a method for producing a foamed extrudate according to a third embodiment. The device 10 contains a main melting device 1 and an auxiliary melting device 2, a first melt 11 being generated in the main melting device 1. In the auxiliary melting device 2, a second melt 12 is produced from a meltable starting material 3. The meltable starting material can be in the form of powder or a granulate. A reactive additive 4 is added to the meltable starting material 3. The reactive additive 4 can, for example, be in the form of a powder, a granulate or a masterbatch. A masterbatch can also be used without any further meltable starting material 3. The plastic 3 is melted together with the reactive additive 4 and a physical blowing agent 17 in the auxiliary melting device 2 to form the second melt 12, so that an additive-containing second melt 14 containing the reactive additive 4 and the physical blowing agent 17 is obtained in the auxiliary melting device 2, wherein the first melt 11 generated in the main melting device 1 is mixed therewith. The main melting device 1 can also be charged with a meltable starting material 5 which is present as a solid, for example as a powder or a granulate. According to an embodiment not shown, the main melting device 1 is supplied with a melt instead of a solid.

For example, the main melting device 1 is configured as a main extruder. For example, the auxiliary melting device 2 is configured as a secondary extruder, in particular as a single-screw extruder. Due to the simple construction, the auxiliary melting device 2 can be obtained inexpensively in the configuration as a single-screw extruder; in addition, an auxiliary melting device 2 can simply be connected to a main melting device 1 or retrofitted.

According to an embodiment, at least one of the reactive additives 4 is added to the auxiliary melting device 2 as a powder or as a granulate. The reactive additive 4 can already be added to the meltable starting material 3 in the feed device 16. If a masterbatch is processed by means of the auxiliary melting device 2, the reactive additive 4 can be contained in the masterbatch.

According to an embodiment, the metering ratio of the second melt 12 with respect to the first melt 11 is less than 1 to 10. According to an embodiment, the metering ratio is less than 1:20. According to an embodiment, the metering ratio is less than 1:50.

According to the embodiment shown in FIG. 3, the additive-containing second melt 14 is added to the first melt 11 in the main melting device 1. In particular, a chemical reaction of the reactive additive 4 can partially take place in the auxiliary melting device 2. In particular, the additive-containing second melt 14 can reach a temperature higher than 160 degrees Celsius at least in a section of the auxiliary melting device 2. According to an embodiment, the additive-containing second melt 14 can reach a temperature higher than 180 degrees Celsius at least in a section of the auxiliary melting device 2. According to an embodiment, the additive-containing second melt 14 can reach a temperature higher than 200 degrees Celsius at least in a section of the auxiliary melting device 2. The temperature of the additive-containing second melt 14 can be higher than the temperature of the first melt 11 before the first melt 11 and the second melt 12 or the additive-containing second melt 14 are mixed.

According to the present embodiment, an optional first cooling device 9 is arranged downstream of the main melting device 1. In addition, as in FIG. 1, a first mixing device 7 can be provided, which is not shown in the drawing. In addition, as in the embodiment shown in FIG. 1, an optional second mixing device 8 and an optional second cooling device 19 can be arranged between the auxiliary melting device 2 and the main melting device 1, so that the additive-containing second melt 14 can be mixed or cooled before it is brought into contact with the first melt 11.

Alternatively, according to an embodiment not shown, a physical blowing agent can be metered into the first melt the main melting device 1 or downstream of the main melting device 1.

It is obvious to a person skilled in the art that many further variants are possible in addition to the embodiments described without departing from the inventive concept. The subject matter of the invention is therefore not restricted by the preceding description and is determined by the scope of protection which is defined by the claims. The broadest possible reading of the claims is authoritative for the interpretation of the claims or the description. In particular, the terms “contain” or “include” are to be interpreted in such a way that they refer to elements, components, or steps in a non-exclusive meaning, which is intended to indicate that the elements, components, or steps can be present or are used that they can be combined with other elements, components or steps that are not explicitly s mentioned. When the claims relate to an element or component from a group which may consist of A, B, C to N elements or components, this formulation should be interpreted in such a way that only a single element of that group is required, and not combination of A and N, B and N, or any other combination of two or more elements or components of this group.

1. A method for producing a foamed extrudate, comprising a main melting device and an auxiliary melting device, wherein a first melt is generated in the main melting device, wherein a second melt is generated in the auxiliary melting device from a meltable starting material, wherein at least one reactive additive is added to the meltable starting material, wherein the at least one reactive additive is selected from the group consisting of a chemical blowing agent and an active nucleating agent or wherein the reactive additive is contained in the meltable starting material, wherein the meltable starting material and the reactive additive are melted in the auxiliary melting device to form the second melt, so that an additive-containing second melt containing the reactive additive is obtained in the auxiliary melting device, which is added to the first melt produced in the main melting device.

2. The method of claim 1, wherein the auxiliary melting device is configured as a single-screw extruder.

3. The method of claim 1, wherein the meltable starting material of the auxiliary melting device is added via a feed device as a powder or as a granulate.

4. The method of claim 1, wherein the reactive additive is added as a powder, a granulate or as a masterbatch.

5. The method of claim 1, wherein a metering ratio of the second melt and the first melt is less than 1 to 10.

6. The method of claim 1, wherein the additive-containing second melt is added to the first melt in the main melting device or downstream of the main melting device.

7. The method of claim 1, wherein the main melting device contains a degassing opening, wherein the additive-containing second melt is added downstream of the degassing opening.

8. The method of claim 1, wherein a chemical reaction of the reactive additive takes place partially in the auxiliary melting device.

9. The method of claim 1, wherein the temperature of the second melt or the additive-containing second melt in the auxiliary melting device reaches a value of more than 160 degrees Celsius at least in a section of the auxiliary melting device.

10. The method of claim 1, wherein the temperature of the second melt or the additive-containing second melt is higher than the temperature of the first melt before the first melt and the additive-containing second melt are mixed.

11. The method of claim 1, wherein at least one element from a group consisting of a first mixing device and a first cooling device is arranged downstream of the main melting device.

12. The method of claim 1, wherein at least one element from a group consisting of a second mixing device and a second cooling device is arranged between the auxiliary melting device and the feed to the first melt.

13. The method of claim 12, wherein the additive-containing second melt is mixed or cooled before it is brought into contact with the first melt.

14. The method of claim 1, wherein the active nucleating agent contains at least one substance from the group consisting of a sodium bicarbonate, a citric acid, and a citric acid derivative.

15. The method of claim 1, wherein a metered amount of the reactive additive is controlled by an angular velocity of a rotatable conveying device arranged in the auxiliary melting device.

16. The method of claim 1, wherein an angular velocity of a rotatable conveying device of the auxiliary melting device is regulated by a throughput-dependent set variable of the main melting device.
